(19) United States
(12) Patent Application Publication
(10) Pub. No.: US 2013/0327103 A1
(43) Pub. Date: Dec. 12, 2013

(54) USE OF ZEOLITES IN SUPPLYING MICRONUTRIENTS

(71) Applicants: Jean-Francois Chollet, Doux (FR); Guy Joly, Lavoux (FR); Patrick Magnoux, Poitiers (FR)

(72) Inventors: Jean-Francois Chollet, Doux (FR); Guy Joly, Lavoux (FR); Patrick Magnoux, Poitiers (FR)

(21) Appl. No.: 14/000,467

(22) PCT Filed: Feb. 15, 2012
(86) PCT No.: PCT/EP2012/052610

§ 371 Date: Aug. 20, 2013

(30) Foreign Application Priority Data
Feb. 22, 2011 (FR) 1151430

(51) Int. Cl. C05D 3/00

(52) U.S. Cl. CPC C05D 3/00
USPC 71/62

(57) ABSTRACT

The invention relates to the use of zeolites for supplying plants with micronutrients that can be assimilated, in particular using a composition including a zeolite and a micronutrient. The invention mainly pertains to the field of agriculture, in particular to the prevention or correction of assessed micronutrient deficiencies in plants grown in open fields or through hydroponics.

This invention relates to the use of zeolites for supplying plants with assimilable micronutrients (or oligoelements or trace elements), in particular with a composition including a zeolite and a micronutrient. The main field of application concerns agriculture, and more specifically the prevention or correction of demonstrated deficiencies in micronutrients of plants grown in fields or hydroponically.

Micronutrients, in particular iron, copper, manganese, zinc, boron, molybdenum, are involved in small doses in plant nutrition. A deficiency or an excess of these elements can cause vegetation disorders. Thus, an iron deficiency is manifested as chlorosis in young leaves and can result in devastation of the crop. Currently, the only existing process for correcting these deficiencies consists of supplying iron complexed with organic molecules, in particular ethylenediaminetetraacetic acid (EDTA) or ethylenediamine-N,N′-bis(2-hydroxyphenylacetic acid) (EDDHA). Numerous known methods are based on the use of such complexes. These are chelates, for example iron chelate used to correct iron chlorosis. Chelate technology has barely evolved since the end of the 1950's. They are costly, thereby limiting the use in plants with a high value added such as grapevines and market garden or ornamental crop cultures. These complexes are for the most part sensitive to light, which degrades them, and some of them are fairly or entirely unstable in alkaline soils. The micronutrient content obviously cannot be modulated. For example, EDDHA-iron chelate contains 6% iron. There is also the question of the effect of organic chelating compounds in soils.

These methods present numerous disadvantages from both an agronomic and an economic perspective. Indeed, the use of such chelated complexes is costly and is not always efficient. These methods also lead to environmental problems because they are based on the dissemination of organic compounds.

A composition in the form of a granule comprising in particular a plant treatment agent and a zeolite core as well as various layers of diatomite or one or more other materials, is known from WO 2005/117581. This document does not mention the exchange of elements in the zeolite implemented, or the use of particular quantities of assimilable micronutrients relative to the quantity of zeolite used.

There is thus a need to be capable of providing plants with the micronutrients necessary for their growth and which do not have the disadvantages or the problems of the known methods.

The present invention therefore relates to a method including the use of a zeolite to provide plants with assimilable micronutrients or mesoelements.

This method makes it possible to solve, entirely or in part, the problems of the known methods.

This method makes it possible in particular to provide an optimal supply of micronutrients near the roots of the plant. In the agronomic field, the invention makes it possible to gradually release a mineral element, in this case a micronutrient or a mesoelement, in the vicinity of the root system of the plant. This makes it possible to prevent or correct deficiencies when necessary, and without leaving toxic residue in the soil.

In addition, the zeolites incorporated in the soil are non-pollutant since they use alumina and silica.

This method according to the present invention has, in particular, the following advantages with respect to the known methods, which use chelates:
the compounds obtained are stables;
the micronutrient content can be modulated without any difficulty and it can be adapted to particular needs;
no toxic residue will remain in the soil.

Advantageously, the zeolites used have a hydrophilic character and can hold up to 30 to 35% of their weight in water, in general without any variation in volume. Thus, the zeolites provided in the soil by the method according to the invention can enable the watering frequency to be reduced. They can thus hold macroelements (ammonium, potassium, for example) reversibly, i.e. act as a temporary storage area and provide the plant with these elements as it needs them.

In addition, the implementation of the method according to the invention is particularly easy and does not require any sophisticated or costly equipment. No toxic product is involved in this method, the solvent used is generally demineralized water, and the production of large amounts on an industrial scale does not present particular problems. The production residues, usually consisting of water and mineral salts, can also be used in agriculture, by making a careful choice of the salt used at the outset.

Moreover, the method according to the invention makes it possible to gradually release a mineral element, in this case a micronutrient or a mesoelement.

Thus, the present invention relates to a method that includes the use of a zeolite in order to provide plants with assimilable micronutrients or mesoelements in a quantity of 0.1 to 25% by mass of zeolite.

Zeolites are aluminosilicate derivatives that can exist in their natural state or that have been modified or prepared specifically. There are different types of zeolites. Thirty-five natural zeolites and more than one hundred synthetic zeolites are known. Each type of zeolite is characterized by the architecture and size of its lattice. Faujasite zeolite (FAU) has a structure identical to that of natural faujasite. It consists, like the other zeolites, of tetrahedra SiO₄ and AlO₄⁻ connected by their oxygen atoms: 24 tetrahedra connected so as to form 8 rings with 6 tetrahedra and 6 rings with 4 tetrahedra form a cube-octahedron also called a sodalite cage or β-cage. The structure of the FAU zeolite can be described as an assembly of cube- octahedra connected to one another by hexagonal prisms. This assembly shows a polyhedral cavity with 26 faces called a supercage and which constitutes the basic unit of the microporosity of this zeolite. Supercages are assimilated to pseudospheres with a diameter of 13 Å and a volume of 850 Å³. They communicate with one another by means of openings with 12 oxygen atoms (7.4 Å in diameter). The β-cage has a diameter of 7.4 Å and a volume of 160 Å³. It is connected to the supercage by openings with 6 oxygen atoms with a diameter of around 3 Å. The basic lattice of the FAU zeolite includes eight B-cages and sixteen hexagonal prisms.

For the method according to the invention, one or more zeolites can be implemented. The zeolite can be of natural origin or it can have been modified or prepared specifically. Numerous zeolites can be suitable for the method according to the invention. As examples of such zeolites suitable for the method according to the invention, it is possible to cite the zeolites described in Zeolites (1996), 17, pp 1-230 published by Elsevier Science.

The method according to the invention generally includes the use of a zeolite of which the pore opening is 12 atoms.

As examples of zeolites with a pore opening of 12 atoms, it is possible to cite AFI (AIPO₄-5), AFR (SAPO-40), AFS (MAPSO-46), AFY (CoAPO-50), ATO (AIPO₄.31), ATS (MAPO-36), BEA (Beta), BOG (Boggsite), BPH (Beryllophosphate-H), CAN (Cancrinite), CON (CIT-1), DFO (DAF-1), EMT (EMC-2), FAU (Faujasite), GME (Gmelinite° LTL (Linde type L), MAZ (Mazzite), MEI (ZSM-18), MOR (Mordenite), MTW (ZSM-12), OFF (Offretite), RON (Roggianite), VET (VPI-8).

For the method according to the invention, a zeolite of which the pore opening is of an opening of 10 atoms or 8 atoms may also be suitable.

As examples of zeolites with a pore opening of 10 atoms, it is possible to cite AEL (AIPO₄-11), AFO (AIPO₄-41), AHT (AIPO₄-H2), DAC (Dachiardite), EPI (Epistilbite), EUO (EU-1), FER (Ferrierite), HEU (Heulandite), LAU (Laumontite), MEL (ZSM-11), MFI (ZSM-5), MFS (ZSM-57), MTT (ZSM-23), NES (NU-87), -PAR (Partheite), STI (Stilbite), TON (Theta-1), WEI (Weinebeneite), WEN (Wenkite).

As examples of zeolites with a pore opening of 8 atoms, it is possible to cite ABW (Li-A (Barrer and White)), AEI (AIPO₄-18), AFT (AIPO₄-52), AFX (SAPO-56), APC (AIPO₄-C), APD (AIPO₄-D), ATN (MAPO-39), ATT (AIPO₄-12-TAMU), ATV (AIPO₄-25), AWW (AIPO₄-22), BIK (Bikitaite), BRE (Brewsterite), CAS (Cesium Aluminosilicate (Araki)), CHA (Chabazite), DDR (Deca-dodecasil 3R), EAB (TMA-E), EDI (Edingtonite), ERI (Erionite), GIS (Gismondine), GOO (Goosecreekite), JBW (NaJ (Barrer and White)), KFI (ZK-5), LEV (Levyne), LTA (Linde type A), MER (Merlinoite), MON (Montesommaite), NAT (Natrolite), PAU (Paulingite), PI-H (Phillilpsite), RHO (Rho), RTE (RUB-3), RTH (RUB-13), THO (Thomsonite), VNI (VP1-9), YUG (Yugawaralite), ZON (ZAPO-M1).

Other zeolites with a pore opening of 9, 14, 18 or 20 atoms can be suitable, for example CHI (Chiavennite), LOV (Lovdarite), RSN (RUB-17), VSV (VPI-7), CLO (Cloverite), VFI (VPI-5), AET (AIPO₄-8).

The characteristics of these zeolites are described in Zeolites (1996), 17, pp 1-230 published by Elsevier Science, in particular on pages 9 to 12.

The method according to the invention implements a zeolite including pores and cages. The pores of the zeolite of the method according to the invention must enable a cation exchange. According to the invention and in general, the zeolite has pores of which the diameter is 4 to 8 A, preferably 5 to 7.5 Å, and in particular 7.4 Å. In general, the zeolite has an alpha supercage diameter of 13 Å.

As examples of zeolites in the composition according to the invention, it is possible to cite the zeolite NaX, Si/Al=1.18 and microporous volume (VM)=0.291 cm³/g, or the zeolite NaY, Si/Al=2.43 and VM=0.345 cm³/g, or the commercial zeolite HY (HFAU40) with Si/Al=32 and VM=0.245 cm³/g.

Preferably, the method according to the invention implements a zeolite of the faujasite type. Advantageously, these zeolites have large pores. They can be obtained in a wide range of compositions by varying the Si/Al ratio and can be represented by the formula (I)

Mⁿ⁺_{x/n}[(AlO₂)ₓ(SiO₂)₁₉₂₋ₓ].zH₂O (I)
wherein
Mⁿ⁺represents a cation of charge n, in general represents 1 or 2;
x represents the number of cations;
[ ] represents the silico-aluminate lattice characterized by the Si/Al ratio;
z represents the number of zeolitic water molecules.

As examples of zeolites, two major types of faujasite are known in particular, according to the Si/Al composition:
faujasites X, of which the Si/Al ratio is between 1 and 1.5;
faujasites Y, of which the Si/Al ratio is between 1.5 and 3.

Faujasites having higher ratios can be prepared by dealumination processes, in particular post-synthesis dealumination processes.

As advantageous zeolites according to the invention, it is possible to cite FAU zeolites from a zeolite that has been entirely dealuminated to the faujasite NaX, Na₉₆FAU. Generally according to the invention, the lattice parameters and the atomic positions of the zeolite useful according to the invention, in particular faujasite, have been fixed, according to a rigid model. It is also possible to use zeolites, in particular faujasite, having a certain freedom of movement, in particular cations; deformations of the openings can also influence the description of the quantity of molecules stored and the desorption dynamics of the composition according to the invention.

Advantageously, the method according to the invention implements a hydrophilic zeolite. Such a hydrophilic zeolite can be chosen from the dehydrated zeolites, in particular from the dehydrated zeolites with pore openings of 12, 10 or 8 atoms. Normally, such a dehydrated zeolite can be obtained by the usual dehydration techniques.

The method according to the invention advantageously includes the implementation of a hydrophilic zeolite of which the Si/Al ratio is between 1 and 2000, preferably between 1 and 1000, and in particular between 5 and 100.

Advantageously, the invention implements zeolites having extra-lattice compensating cations of which the role is to neutralize the negative charge located on the AlO₄⁻ tetrahedra of the lattice. Preferably, these extra-lattice cations are Na⁺ ions and they will be capable of being exchanged with other cations, in particular the cations involved in plant micronutrition. In formula (I), M represents such a compensating cation.

The particle size of the zeolite implemented according to the invention can be chosen so as to improve the efficacy of the method according to the invention. The particle size of the zeolite is generally between 0.01 and 0.8 mm, preferably between 0.1 and 0.5 mm, in particular between 0.2 and 0.4 mm Once formulated, the zeolite can be in a rather large number of forms, for example in extruded form or in the form of granules, generally produced from zeolite powder and a binding agent.

Aside from a zeolite, the method according to the invention implements a micronutrient. A plurality of micronutrients can also be implemented. A large number of micronutrients may be suitable.

According to the method of the invention, the micronutrient can be included in the zeolite implemented.

Advantageously, the micronutrient is chosen according to the zeolite implemented, in particular according to the parameters of pore size, cage volume and number of aluminium atoms present in the structure of the zeolite. Thus, the micronutrient is included in the zeolite. In the zeolite, the micronutrient is in the position of exchange, in particular by establishing ion bonds with the oxygen atoms of the zeolite structure. In the composition according to the invention, all or some of the micronutrient can also be found outside of the lattice that forms the zeolite.

Numerous micronutrients can be suitable for the invention. These micronutrients are preferably chosen according to their role in the plant, in particular in oxidation-reduction reactions of the enzymatic system of these plants, in particular photosynthesis, nitrogen fixation, nitrate reduction in the plant, alteration of mitochondrial respiration, etc. Thus, the micronutrient can be chosen from copper, manganese, zinc, molybdenum and iron; preferably, iron or copper.

Other elements can play a useful role for certain plant species, in particular cobalt and selenium, which can be implemented as a micronutrient according to the invention. For the invention, it is also suitable to consider the mesoelements, which are intermediate elements between major elements and trace elements, for example calcium and magnesium.

For the present invention, the micronutrient that is implemented can be replaced or combined with one or more mesoelements.

In the case of faujasite zeolites, the extra-lattice compensating cations are generally distributed on three main types of sites:
sites I are located at the centre of the hexagonal prisms (16 positions per lattice);
sites II are located in the supercage, centred on the hexagonal windows of the sodalite blocks (32 positions per lattice);
sites III are located at the level of the windows of the supercage, outside of the crystallographic axes of the zeolite (the presence of sites III is specific to type-X structures); as well as on
secondary sites I′, II′ and III′ which correspond to positions symmetrical to sites I, II and III with respect to the plane delimited by the nearest hexagonal window of a sodalite block.

Particularly advantageously, the invention implements a zeolite of the NaX type in combination with iron.

For the present invention, the quantity of trace element varies from 0.1 to 25% by mass of zeolite, and this quantity preferably varies from 1 to 20%, for example from 1.5 to 15% by mass of zeolite.

The invention also relates to a method for preparing a composition implemented according to the invention. Particularly advantageously, the composition according to the invention can be prepared according to a very effective and easy method. This method implements the general principle of the exchange of ions of the zeolite with the cation(s) of the trace elements chosen. This exchange is performed while stirring and in a liquid medium, for example in water.

Thus, for a given ion exchange, the zeolite is placed in contact with an aqueous salt solution, for example nitrate, sulfate, chloride or acetate of the cation to be substituted for the ions of the zeolite, for example Nat The zeolite is kept in suspension by stirring, generally at room temperature, in a saline solution of which the concentration may be adapted according to the targeted exchange rate. This stirring is generally maintained for a time capable of ranging from several minutes to several hours, for example from 0.5 to 20 h, in particular from 2 to 10 h, for example for 8 h. A saline solution concentration of around 1 mol1⁻¹ is enough to have a maximum exchange. For exchanges implementing 5 to 25 g of zeolite, the volume of solution used is, for example, equal to 10 ml per gram of hydrated zeolite to be exchanged. The zeolite is then washed (for example, for 5 g of zeolite with 3×50 ml of water), isolated by filtration, for example in a Büchner funnel, then dried, for example in a drying chamber at a temperature varying around 80° C. for a period of around 2 to 20 h, in particular 6 to 12 h.

According to the preparation method according to the invention, it is possible to measure and control the exchange rate of the zeolite used. Thus, the basic analysis of the elements of the zeolite, for example, Al, Si, Na and the compensating cation, can be performed by the ICP (induced coupled plasma) emission technique.

Advantageously, the preparation method according to the invention makes it possible to prepare compositions of which the micronutrient content varies from 0.1 to 20% by mass of zeolite, preferably ranging from 1 to 15% by mass of zeolite.

Thus, from copper nitrate (Cu(NO₃)₂,3H₂O), it is possible to prepare type-X zeolites with copper contents of between 1 and 10%. The ICP analyses of the hydrated zeolites obtained lead to ion levels with a Cu percentage in the X zeolite (mass/mass) of 1.22, 4.60, 6.97 and 10.1%.

For large-scale preparations, in particular on the order of 20 kg of NaX zeolite, a content of 5% copper is accessible. Similarly, from NaX zeolite and using iron chloride (FeCl₂,4H₂O), zeolites with contents ranging from 1 to 20% (mass/mass) can be prepared, in particular at contents ranging from 2 to 12%.

Zeolites exchanged with magnesium can also be prepared, for example with an NaY faujasite. In this case, a cation exchange of 0.32 corresponds to a magnesium content of 1.2% (mass/mass).

In the preparation of the composition according to the invention, the monitoring of the exchange can be performed by assay according to a spectrometric method, for example with 1,10-phenanthroline (Afnor NF T 90-017 standard) for the iron assay.

The equipment necessary for preparing the composition implemented according to the invention is relatively simple. It can be a container and a stirring system suitable for the amounts to be prepared: for example, glass bottles and an orbital stirrer for volumes in the order of a litre, plastic cans or vats and a stirring motor with a blade stirrer for volumes of several dozen litres or more. Similar devices are implemented for larger-scale preparations, in particular on an industrial scale.

Advantageously, the aqueous phase recovered after filtration can be reused several times. It is thus gradually enriched with compensating cations coming from the zeolite, for example Na⁺ but also NH₄⁺, Mg²⁺ for a subsequent valorization of this solution, in particular for plant nutrition in association with the anion from the salt implemented for the cation exchange, for example, NO₃⁻, SO₄²⁻, PO₄³⁻. Thus, this solution can be recycled and valued owing to the presence, for example, of sodium nitrate or ammonium nitrate.

The invention therefore also relates to such a method of which the by-products can be valued and chosen from the salts of the exchanged cation of the zeolite and the counteranion of the micronutrient or the mesoelement implemented.

The invention also relates to a method for treating plants by means of a composition including a zeolite exchanged or including one or more micronutrients. Particularly advantageously, the treatment method according to the invention makes it possible to control the release of the micronutrient.

The treatment method according to the invention usually implements micronutrient doses ranging from 0.1 to 600,000 g/ha, preferably from 10 to 50,000 g/ha, for example from 50 to 20,000 g/ha. Advantageously, the method according to the invention implements a trace element dose applied per foot of plant treated. In particular, the method according to the invention can be implemented per foot or vine stock or fruit tree. Thus, for iron, these doses can range from 0.12 to 0.30 g per vine stock or 1.8 to 15 g per fruit tree.

These doses may be adapted according to the composition of the invention that is used as well as according to climactic conditions, any resistance phenomena or other natural factors, the nature of the treatment or the degree of deficiency, as well as according to the plants or the sites to be treated.

Usually for the treatment of plants, the composition implemented according to the invention enables a release of the micronutrient according to the desorption equilibrium triggered by the plant. It is thus possible to reduce micronutrient losses in the soil because the micronutrient penetrates the plant, then circulates within it, moving the desorption equilibrium according to this penetration directly into the plant.

During the implementation of the treatment method according to the invention, the micronutrient usually desorbs in a linear manner. However, some factors may enable this desorption to be adapted or influenced.

Thus, the hydrophilic character (characterized by the Si/Al ratio) of the zeolite can influence the rate of desorption in water (static desorption): generally, the more hydrophilic the zeolite is, the faster and more constant the desorption is; the particle size can also enable a variation in the rate of desorption of the micronutrient, and a careful mixture of various particles sizes can make it possible to work with the persistence and control the quantity of active material released over time; the carrying capacity can also have an influence, as a zeolite loaded to its maximum normally releases a larger quantity of micronutrients than a zeolite with a light or moderate load.

By working with all of these factors in a specific or combined manner, it is therefore possible to arrive at a zeolite- micronutrient combination having the desired behaviour: in particular, slow and constant desorption of the micronutrients over time, thus preventing an excessive supply.

The plants capable of being treated by the method according to the invention can be chosen from: cotton; flax; vine; fruits and vegetables such as Rosaceae sp. (for example fruits with seeds such as pears or apples, fruits with cores such as apricots, almonds and peaches), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example, bananas and plantains), Rubiaceae sp., Theaceae sp., Sterculiceae sp., Rutaceae sp. (for example, lemon, orange, grapefruit); Solanaceae sp. (for example tomatoes, potatoes, sweet peppers, aubergines), Liliaceae sp., Asteraceae sp. (for example, lettuce), Umbelliferae sp., Chenopodiaceae sp., Cucurbitaceae sp., Papilionaceae sp. (for example, peas), Rosaceae sp. (for example, strawberries); major crops such as Graminae sp. (for example, corn, sod, grains such as wheat, rice, oats, barley, triticale), Asteraceae sp. (for example, sunflower), Cruciferae sp. (for example, rapeseed), Fabacae sp. (for example, peanuts, peas, beans), Papilionaceae sp. (for example, soya beans), Chenopodiaceae sp. (for example, beets); oleaginous plants such as Brassta napus (for example, canola), Brassica rapa, Brassica juncea (for example, mustard); Brassica carinata; Ribesioidae sp., Jugletaceae sp., Betulaceae sp., Anacardiaceae sp., Fagaceae sp., Moraceae sp., Oleaceae sp., Actinidaceae sp., Lauraceae sp., Rubiaceae sp. (such as coffee), Theaceae sp., Sterculiceae sp., Liliaceae sp., Compositiae sp. (such as lettuce, artichokes, endive, chicory), Umbelliferae sp. (such as carrots, parsley, celery), Cucurbitaceae sp. (such as cucumber, melons, squash), Alliaceae sp. (such as onions, garlic), Cruciferae sp. (such as cabbage, broccoli, bok choy, radishes, watercress), Leguminosae sp., Chenopodiaceae sp. (such as spinach, beetroot), Malvaceae sp., Asparagaceae, horticultural crops, for example, rosebushes, and forest crops; or genetically modified homologues of these plants.

The treatment method according to the invention also makes it possible to better fight certain deficiencies of plants for which there are only few effective solutions. For example, the treatment method according to the invention makes it possible to fight iron deficiencies or iron chlorosis, in particular of the grapevine or rosebush.

The following examples illustrate the process of the invention, in particular the advantages of this process.

### EXAMPLE 1

### Preparation of NaX Faujasite Zeolite Compositions exchanged with Copper

The composition including an exchanged zeolite is prepared from a faujasite zeolite Na₈₈X (Si/Al=1.2) industrially synthesized by Ceca (La Garenne Colombes, France). The zeolite is used as is, i.e., it does not contain any binder and is not formed at the outset.

A glass bottle and an orbital stirrer are used. The zeolite is placed in contact with an aqueous copper nitrate solution (Cu(_{NO}₃)₂,3H₂0) in order to replace the Na⁺ ions with copper. The zeolite is kept suspended by stirring for 8 hours at room temperature in the saline solution of which the concentration varies according to the desired exchange rate. To have a maximum exchange, the concentration of the solution is around 1 mol.1⁻¹. For exchanges implementing 5 to 25 g of zeolite, the volume of solution used is equal to 10 ml per gram of hydrated zeolite to be exchanged. The zeolite is then washed (for 5 g of zeolite, 3×50 ml of water), isolated by filtration on a Büchner filter, then dried in a drying chamber (80° C. for one night).

The exchange rate of the zeolites obtained is calculated on the basis of the basic analysis of the faujasites (mass percentages of Al, Si, Na and compensating cation) performed by the ICP (Induced Coupled Plasma) emission technique. The ICP analyses of the hydrated zeolites obtained lead to the ion contents presented in table 1.

TABLE 1

Example

| | 1.1 | 1.2 | 1.3 | 1.4 |
|---|---|---|---|---|
| Quantity of Cu in the X | 1.22 | 4.60 | 6.97 | 10.1 |
| zeolite (% mass/mass) | | | | |

### EXAMPLE 2

### Preparation of NaX Faujasite Zeolite Compositions exchanged with Iron

According to the method of example 1, the composition including an exchanged zeolite is prepared by using iron chloride (FeCl₂,4H₂O).

The exchange rate of the zeolites obtained is calculated on the basis of the basic analysis of the faujasites (mass percentages of Al, Si, Na and compensating cation) performed by the ICP (Induced Coupled Plasma) emission technique. The ICP analyses of the hydrated zeolites obtained lead to the ion contents presented in table .

TABLE 2

Example

| | 2.1 | 2.2 | 2.3 | 2.4 |
|---|---|---|---|---|
| Quantity of Fe in the X | 0.96 | 4.98 | 7.10 | 10.30 |
| zeolite (% mass/mass) | | | | |

### EXAMPLE 3

### Preparation of NaY Faujasite Zeolite Compositions exchanged with Magnesium

According to the method of example 1, the composition including an exchanged zeolite is prepared by using magnesium chloride (MgSO₄). The composition including an exchanged zeolite is prepared from a faujasite zeolite Na₅₆Y (Si/Al =2.4) industrially synthesized by Zeolyst International (Conshohocken, Pa., USA).

The exchange rate of the zeolites obtained is calculated on the basis of the basic analysis of the faujasites (mass percentages of Al, Si, Na and compensating cation) performed by the ICP (Induced Coupled Plasma) emission technique. The ICP analyses of the hydrated zeolite obtained show an ion content corresponding to a quantity of Mg in the Y zeolite (% mass/mass) of 1.2%.

### EXAMPLE 4

### Preparation of NaX Faujasite Zeolite Compositions exchanged with Copper on a Semi-industrial Scale

The composition including an exchanged zeolite is prepared from a faujasite zeolite Na₈₈X (Si/Al=1.2) industrially synthesized by Ceca (La Garenne Colombes, France). The zeolite used is as is, i.e., it does not contain any binder and is not formed at the outset: 5 kg of NaX zeolite are dispersed in a solution of 15 litres of distilled water containing 915 g of trihydrated copper nitrate. After 8 hours of mechanical stiffing, the solution is decanted for 24 hours. The upper aqueous phase is then drawn off with a pump, then the zeolite is dried in a drying chamber at 80° C. for 8 hours. The zeolite having a content of 5% copper thus obtained is ready for use.

The simplicity and speed of implementation of the process may be noted.

### EXAMPLE 5

### Treatment of Rosebushes with a Composition according to the Invention

The zeolites prepared according to example 2 were evaluated for their capacity for correcting deficiencies, in particular of iron (iron chlorosis), a common deficiency that is easy to identify. The chlorotic plants were obtained by working in a hydroponic environment in order to perfectly control the nutrient supplies.

Dwarf rose cuttings were placed on vermiculite, an inert substrate having good water retention capacities. The plants are arranged on 3 tide tables irrigated independently by immersion of the pots for 30 minutes per day in a nutrient liquid developed according to the formula of Hoagland and Snyder, Proc. Amer. Soc. Hort. Sci., 30, p288, 1933.

Three plant batches are thus produced:
a first control group receives the nutrient liquid from which the iron supply has been removed;
a second batch receives the nutrient liquid in which the iron is supplied by an EDDHA iron (Sequestren®, 6% iron) in an amount of 17 mg of commercial product per litre of solution (around 1 mg of iron per litre, i.e. 17.9 μM); finally,
a third batch receives a nutrient solution identical to the control batch, i.e. without iron. However, in this case, a zeolite doped with around 5% iron (prepared according to example 2.2) is directly incorporated in the culture substrate in an amount of 2 different does: 0.2 g or 1 g per pot, which represents, respectively, a supply of 0.01 and 0.05 g of iron per pot. The zeolite was distributed over the surface of the pot, then lightly incorporated at the surface.

At the start, the cuttings are watered, then placed under a horticultural fabric for 2 weeks without any additional watering, so as to have a maximum hygrometry promoting the birth of roots. The cloth is then removed and the daily irrigation cycle is established.

The cuttings irrigated by a solution without any iron in its composition do not grow and end up disappearing. The plants that receive the nutrient solution supplemented iron chelate grow but with a chlorotic tendency, certainly due to an insufficient iron supply. The plants that have received 0.2 g of zeolite doped with around 5% iron per pot have an appearance entirely similar to the plants treated with iron chelate. Finally, the plants having received 1 g of zeolite doped with around 5% iron per pot do not have any apparent sign of deficiency.

The iron chlorosis was therefore perfectly corrected and the plants were able to resume normal growth. In addition, once all of the iron was released, only non-polluting zeolite will remain in the soil, which can even have a beneficial secondary role as a “buffer” for macroelements such as nitrogen or potassium.

### EXAMPLE 6

### Treatment of Grapevine Plants with a Composition according to the Invention

The experiments of example 5 were reproduced on the grapevine, a plant also very sensitive to iron deficiencies. Grapevine cuttings with two eyes (young shoots from the previous year) are planted in rockwool blocks, the latter then being deposited on tide tables for daily irrigation by immersion (2×20 minutes/day). The nutrient solution used in this case was based on Scotts soluble fertilizer (Peter professional, 20-20-20 General Purpose™). This fertilizer contains 0.05% DTPA-iron chelate, an insufficient quantity in the case of the grapevine since the characteristic symptoms of iron chlorosis appear quickly during growth of the herbaceous parts.

75 days after cutting, two distinct batches of plants have been produced:
the first received the basic nutrient solution supplemented with EDDHA-iron chelate (Sequestren®, in the end 27.9 μM of iron in solution);
the second was watered with the basic nutrient solution and a zeolite doped with iron was incorporated in the rockwool blocks: 8 holes were drilled at mid-height in the blocks on their periphery in which 0.25 g, i.e. 1 g of zeolite with around 5% iron (produced according to example 2.2) were distributed.

75 days after planting on rockwool blocks (day D), a significant yellowing of the leaves due to a chlorophyll deficiency caused by an iron deficit is noted. The addition of Sequestren® (EDDHA-iron chelate) to the nutrient solution at D+12 causes the leaves to recover their green colour, but incompletely.

The incorporation in the rockwool block of zeolite doped with around 5% iron at D+6 causes the plant to begin turning green again.

The incorporation in the rockwool block of zeolite doped with around 5% iron at D+43 causes the plants to grow very vigorously, and no sign of deficiency can be seen.

No notable difference appears between the two doses applied (0.2 and 1 g of zeolite with around 5% iron per plant) over the period considered.

A single incorporation of zeolites doped with iron in the culture substrate therefore showed a biological efficacy at least equivalent to that obtained by continuously supplementing the nutrient solution with chelated iron by an organic compound (EDDHA). The deficiency is perfectly and sustainably corrected. In addition, once all of the iron has been released, only the non-polluting zeolite remains in the soil, which can even play a beneficial secondary role as “buffer” for macroelements such as nitrogen or potassium.

### EXAMPLE 7

### Treatment of Rosebush Plants with a Composition according to the Invention, Control of Morphogenesis and Resistance to Diseases

To evaluate the possibility of replacing the known treatments for controlling the morphology of woody and ornamental plants, in particular rosebushes, experiments have been conducted according to the use of the invention.

Normally, the morphology of ornamental woody plants is controlled by the horticulturist using growth-regulating agents. Paclobutrazol, which belongs to the triazole family, is one of the active materials that can be found in these growth-regulating products. This molecule inhibits the biosynthesis of gibberellins responsible in particular for elongation of the internodes.

However, the toxicity of triazoles leads the user to take significant precautions and to comply with long persistence periods, for example 120 days for rapeseed or 30 days for the peach tree.

When it is applied to crops, the growth-regulating agent induces a reduction in longitudinal growth and an increase in radial growth. The horticulturist thus obtains plants with stubby stems having an erect shoot making it possible to support numerous flower heads.

This therefore involves a substitution for paclobutrazol treatments in the control of ornamental plant morphogenesis.

According to the use of the invention, zeolite/copper combinations are incorporated in the culture substrates or supplied via a nutrient solution.

It was thus possible to eliminate foliar sprays while enabling slow and durable growth of the copper near the root system and thus control the concentrations of copper available to the treated plant.

The copper concentrations absorbed by the plant were analysed by assaying the copper in the xylem sap by atomic absorption. Thus, the xylem sap of rosebushes grown on a substrate in which zeolite with 1% copper has been incorporated contains 4.35±0.5 μmol.1⁻¹ of copper, while the sap of control plants grown under the same conditions on the substrate alone contains only 0.8±0.05 μmol.1⁻¹, i.e. more than 5 times less. The copper was therefore released by the zeolite and then absorbed by the plant. There is therefore an assimilation of the copper by the plant.

In the treatment of rosebush plants (Marseille variety sold under the Forever trademark), by incorporating zeolite with 1% Cu with the culture substrate, a decrease in the longitudinal growth as well as an increase in the radial growth of the main stem was demonstrated by comparison with control plants (Table 3). At the first internode, the diameter of the stem of plants grown on a substrate containing a zeolite exchanged with 1% Cu is increased by around 10% (example 7.3) by comparison with control plants (example 7.1) or plants treated with paclobutrazol (example 7.2). At the fourth internode, the diameter of the stem of the plants grown on a substrate containing a zeolite exchanged with 1% Cu is increased by around 13% (example 7.6) by comparison with control plants (example 7.4) and it is identical to that of the plants treated with paclobutrazol (example 7.5). With regard to the length of the stem, the effect of the treatment with the zeolite exchanged with 1% Cu (examples 7.3 and 7.6) is identical to that performed with paclobutrazol (examples 7.2 and 7.5), for both the first and the fourth internodes. A reduction by around 25% of the length of the stem is then observed with respect to the control plants not having received any treatment (examples 7.1 and 7.4). Overall, the treatment by incorporation with the zeolite substrate exchanged with 1% Cu produces plants that are more homogeneous than do the paclobutrazol sprays.

TABLE 3

| | 1st internode | | | 4th internode | | |
|---|---|---|---|---|---|---|
| | Example | | | | | |
| | | | 7.3 | | | 7.6 |
| | | 7.2 | Zeolite | | 7.5 | Zeolite |
| | 7.1 | Paclobutrazol | 1% Cu | 7.4 | Paclobutrazol | 1% Cu |
| Measurement | Control | treatment | treatment | Control | treatment | treatment |
| Diameter of | 2.90 ± 0.02 | 2.90 ± 0.034 | 3.23 ± 0.01 | 2.86 ± 0.027 | 3.20 ± 0.04 | 3.23 ± 0.013 |
| the stem (mm) | | | | | | |
| Length of the | 2.60 ± 0.35 | 1.90 ± 0.32 | 2.00 ± 0.27 | 2.90 ± 0.50 | 2.20 ± 0.46 | 2.00 ± 0.32 |
| stem (cm) | | | | | | |

The zeolites exchanged with copper make it possible to obtain rosebush plants having stubby and woody stems without applying growth regulators (by comparison with the use of paclobutrazol, trade name Bonzi, as a reference growth regulator in floriculture).

By visual inspection and comparison (table 3), it is noted that the size of the stems in each pot treated by the combination of zeolite/copper according to the invention is homogeneous. The stems are floriferous and branchy. The lignification of the xylem tissue, in particular the walls of the fibres, is increased.

Thus, the longitudinal growth of the stems will be limited in favour of radial growth.

These treatments with 1% copper with respect to the quantity of zeolite also made it possible to observe resistance to diseases by a reduction in sensitivity to oidium in the plants treated.

Moreover, the lignification of the xylem tissue of the stems and leaves reinforces the parietal structure. Consequently, the role of physical barrier of the wall is increased, reducing the sensitivity of the plants to pathogens, in particular surface fungi such as oidium.

1. A method of supplying plants with assimilable micronutrients or mesoelements, comprising providing to the plants a composition comprising a zeolite and said micronutrients or mesolements in a quantity of 0.1 to 25% by mass of zeolite.

2. The method according to claim 1, wherein the zeolite is of natural origin or is modified or prepared specifically.

3. The method according to claim 1, wherein
the zeolite has a pore opening of 12 atoms and is selected the group consisting of: AFI (AIPO₄-5), AFR (SAPO-40), AFS (MAPSO-46), AFY (CoAPO-50), ATO (AIPO₄.31), ATS (MAPO-36), BEA (Beta), BOG (Boggsite), BPH (Beryllophosphate-H), CAN (Cancrinite), CON (CIT-1), DFO (DAF-1), EMT (EMC-2), FAU (Faujasite), GME (Gmelinite), LTL (Linde type L), MAZ (Mazzite), MEI (ZSM-18), MOR (Mordenite), MTW (ZSM-12), OFF (Offretite), RON (Roggianite), and VET (VPI-8); or
the zeolite has a pore opening is of 10 atoms and is selected the group consisting of: AEL (AIPO₄-11), AFO (AIPO₄-41), AHT (AIPO₄-H2), DAC (Dachiardite), EPI (Epistilbite), EUO (EU-1), FER (Ferrierite), HEU (Heulandite), LAU (Laumontite), MEL (ZSM-11), MFI (ZSM-5), MFS (ZSM-57), MTT (ZSM-23), NES (NU-87), -PAR (Partheite), STI (Stilbite), TON (Theta-1), WEI (Weinebeneite), and WEN (Wenkite); or
the zeolite has a pore opening is of 8 atoms and is selected the group consisting of: ABW (Li-A (Barrer and White)), AEI (AIPO₄-18), AFT (AIPO₄-52), AFX (SAPO-56), APC (AIPO₄-C), APD (AIPO₄-D), ATN (MAPO-39), ATT (AIPO₄-12-TAMU), ATV (AIPO₄-25), AWW (AIPO₄-22), BIK (Bikitaite), BRE (Brewsterite), CAS (Cesium Aluminosilicate (Araki)), CHA (Chabazite), DDR (Deca-dodecasil 3R), EAB (TMA-E), EDI (Edingtonite), ERI (Erionite), GIS (Gismondine), GOO (Goosecreekite), JBW (NaJ (Barrer and White)), KFI (ZK-5), LEV (Levyne), LTA (Linde type A), MER (Merlinoite), MON (Montesommaite), NAT (Natrolite), PAU (Paulingite), PI-H (Phillilpsite), RHO (Rho), RTE (RUB-3), RTH (RUB-13), THO (Thomsonite), VNI (VP1-9), YUG (Yugawaralite), and ZON (ZAPO-M1); or
the zeolite has a pore opening is of 9, 14, 18 or 20 atoms and is selected the group consisting of: CHI (Chiavennite), LOV (Lovdarite), RSN (RUB-17), VSV (VPI-7), CLO (Cloverite), VFI (VPI-5), and AET (AIPO₄-8).

4. The method according to claim 1, wherein the zeolite is a faujasite-type zeolite.

5. The method according to claim 1, wherein the zeolite is of formula (I)
Mⁿ⁺_{x/n}[(AlO₂)ₓ(SiO₂)₁₉₂₋ₓ].zH₂O (I),
wherein
Mⁿ⁻ represents a cation of charge n, in general represents 1 or 2;
x represents the number of cations;
[(AlO₂)x(SiO₂)₁₉₂₋ₓ] represents a silico-aluminate lattice characterized by the Si/Al ratio; and
z represents the number of zeolitic water molecules.

6. The method according to claim 1, wherein the zeolite is selected from the X faujasites having an Si/Al ratio is between 1 and 1.5 or the Y faujasites having an Si/Al ratio between 1.5 and 3.

7. The method according to claim 1, wherein the zeolite is a hydrophilic zeolite.

8. The method according to claim 1, wherein the micronutrient is copper, manganese, zinc, molybdenum, selenium, cobalt or iron, and the mesoelement is calcium or magnesium.

9. The method according to claim 1, wherein the quantity of micronutrient is from 1.5 to 15% by mass of zeolite.

10. A method for treating plants, comprising the method according to claim 1.

11. The method according to claim 10 for fighting iron deficiencies or iron chlorosis.

12. The method according to claim 10 for the treatment of grapevines or rosebushes.

13. A method for preparing a composition including a zeolite and a micronutrient or a mesoelement by in a quantity of 0.1 to 25% by mass of zeolite, comprising exchanging zeolite ions with the cation(s) of the micronutrient or the mesoelement.

14. The method according to claim 13 performed in a non-toxic solvent.

15. The method according to claim 14 performed in water.

16. The method according to claim 13, wherein the zeolite ion is NH₄⁺, K⁺, Na⁺ or Ca²⁺.

17. The method according to claim 13, wherein the by-products can be reclaimed and chosen from the salts of the exchanged cation of the zeolite and the counteranion of the micronutrient or the mesoelement implemented.

18. The method according to claim 17 wherein the counteranion of the micronutrient or mesoelement is NO₃⁻, SO₄²⁻, or PO₄³⁻.
